(19) United States
(12) Patent Application Publication
(10) Pub. No.: US 2023/0408081 A1
(43) Pub. Date: Dec. 21, 2023

(54) Lighted Walking Stick

(71) Applicant: Ce Fang, Ningbo (CN)

(72) Inventor: Ce Fang, Ningbo (CN)

(21) Appl. No.: 17/835,313

(22) Filed: Jun. 8, 2022

(51) Int. Cl. F21V 33/00; F21L 4/00; F21V 23/04; A45B 3/04; A45B 9/02

(52) U.S. Cl. CPC F21V 33/0064; F21L 4/00; F21V 23/04; A45B 3/04; A45B 9/02; A45B 2200/05; A45B 2009/007

(57) ABSTRACT

A walking stick includes a battery and a plurality of lighting elements to provide additional lighting for mobility impaired individuals while walking.

### FIELD OF THE INVENTION

The present disclosure relates to a walking stick, specifically to a walking stick including battery-operated lighting features.

### BACKGROUND OF THE INVENTION

People with various levels of mobility impairments can benefit from the use of a walking stick or cane. People with weak legs, walking disabilities or other mobility impairments use sticks or canes of various designs to assist in walking. Walking sticks are also used by people without mobility impairments, for assistance in hiking or walking over rough terrain. Canes or sticks may reduce the weight burden placed on the legs and core, and can provide additional balance and support when walking on uneven surfaces. Walking sticks or canes may be light alloy single-leg sticks, multi-leg sticks, forearm or F-shaped sticks, or Matsuba ergonomic sticks.

While walking sticks may provide assistance by reducing the weight burden and providing additional balance, users with mobility impairments may still encounter difficulties in walking in areas with poor lighting or visibility. For this reason, there exists a need for walking sticks or canes that can provide assistance in poor lighting or in areas with limited visibility.

### SUMMARY OF THE INVENTION

A walking stick includes a battery and a plurality of lighting elements to provide additional lighting for mobility impaired individuals while walking. In one embodiment, the walking stick may comprise a handle with interior cavity, a telescoping tube, a telescoping tube joint, and a foot pad. The interior cavity may further comprise a battery, a front-facing headlight, a downward-facing sidelight, and a switch button to control operation of the front-facing headlight and the downward-facing sidelight.

### BRIEF DESCRIPTION OF THE DRAWINGS

FIG. 1 is one embodiment of a walking stick.

FIG. 2 is a detailed drawing of one embodiment of the handle of a walking stick.

### DETAILED DESCRIPTION

The following description includes specific details to provide an understanding of the present invention. Embodiments of the present invention described in the following description may be incorporated into other devices not disclosed in the following description. Structures and elements shown in the drawings are exemplary embodiments of the present invention and are not to be used to limit broader teachings of the present invention.

It is understood through the text of this disclosure that where elements are described as separate functional units, those skilled in the art will recognize that various elements or portions thereof may be integrated together. Where elements are described in the following description as integrated together into a combined element, those skilled in the art will similarly recognize that individual elements of the combination may be utilized as separate elements.

This specification includes references to “an embodiment of the present invention” or “one embodiment of the present invention”. This language is intended to refer to the particular elements and structures of the embodiment being discussed in that portion of the specification. Where references are made to “an embodiment of the present invention” or “one embodiment of the present invention” in other portions of the specification, those similarly refer to those particular elements and structures of the embodiment being discussed in that portion of the specification. Embodiments discussed in different portions of the specification may or may not refer to the same embodiment of the present invention.

This specification uses the term “stick”, where any number of similar terms could be used, including but not limited to “cane” and “pole”.

The use of specific terminology in the specification is used for best describing the present invention and shall not be construed as limiting. The terms “include”, “including”, “comprise” and “comprising” shall be understood to be open terminology and not limiting the listed items.

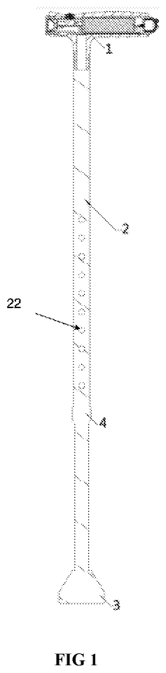

FIG. 1 shows one embodiment of a walking stick. The walking stick may include a handle 1, a telescoping tube 2, a joint 4 and a foot pad 3. The telescoping tube 2 includes holes 22 which allow telescoping tube 2 to be lengthened or shortened. One of holes 22 may lock into a spring-tensioned tab or other securing apparatus inside joint 4 to allow the stick to be lengthened or shortened to a walker's specific size.

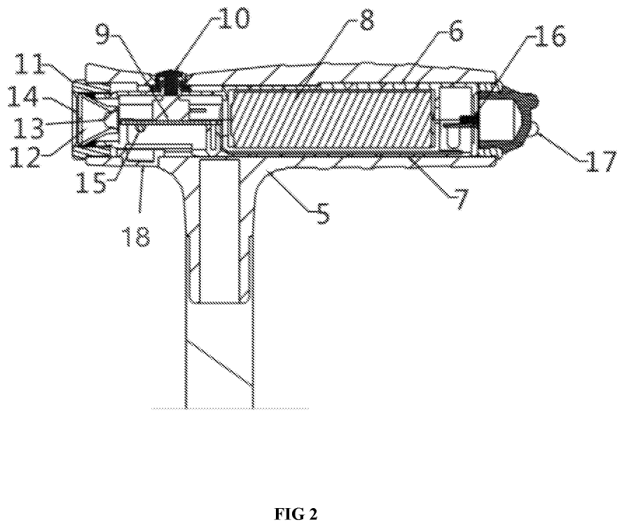

FIG. 2 shows a detailed drawing of one embodiment of handle 1. Handle 1 may include a handle body 5 which encloses the components in an interior cavity inside handle 1. Upper bracket cover 6 and lower bracket cover 7 may enclose battery 8. Switch button 10 may be mounted on the top of handle body 5 and may be connected to drive board 9. Switch button 10 is shown in FIG. 2 as mounted on the top of handle body 5, but switch button 10 may be mounted on another surface of handle body 5. Battery 8 may be electrically connected to drive board 9. Drive board 9 may include electronics capable to control operation of the walking stick. In some embodiments, battery 8 may be a non-rechargeable battery. In other embodiments, battery 8 may be a rechargeable battery.

Head ring 11 may enclose a lighting apparatus at the front side of handle body 5. Head ring 11 may enclose the components of the lighting apparatus. Headlight 13 may be positioned at the narrow end of convex optical cup 12. Drive board 9 may be electrically connected to headlight 13 to provide power to operate side light 15. Headlight lens 14 may be positioned at the wide end of optical cup 12 to focus light generated from headlight 13. The arrangement of elements in the lighting apparatus at the front side of handle body 5 shown in FIG. 2 is merely for illustrative purposes. Other embodiments of the walking stick may not include all elements of FIG. 2.

On the bottom side of the handle body 5, side light 15 may be positioned to provide lighting in a downward direction to assist in improving a walker's view of the walking surface. Drive board 9 may be electrically connected to side light 15 to provide power to operate side light 15. Side light lens 18 may be positioned beneath side light 15 to focus light from side light 15.

The rear of handle body 5 may include an optional charging interface 16 for a rechargeable battery 8. Charging interface 16 may be electrically connected to drive board 9 and battery 8 to enable charging of battery 8 via charging interface 16 and charging plug 17. Charging interface 16 may utilize USB-A, USB-C, micro-USB or any other standard charging protocol. Charging interface 16 may optionally utilize a proprietary charging protocol. In other embodiments, battery 8 may be a non-rechargeable battery.

In operation, a user may activate the lighting features of the walking stick by depressing switch button 10. In one embodiment, a single press of switch button 10 may activate only headlight 13. A second press of switch button 10 may deactivate headlight 13 and activate side light 15. In one embodiment, a third press of switch button 10 may de-activate both headlight 13 and side light 15. In another embodiment, a third press of switch button 10 may activate both headlight 13 and side light 15, and a fourth press of switch button 10 may de-activate both headlight 13 and side light 15. In another embodiment, a single press of switch button 10 may activate headlight 13 in a low-power mode to save power. A second press of switch button 10 may activate headlight 13 in a high-power mode for maximum illumination. A third press of switch button 10 may activate side light 15 in addition to headlight 13. A fourth press of switch button 10 may de-activate both headlight 13 and side light 15. These embodiments are used to demonstrate the invention, and should not be interpreted as limiting. Other combinations of presses of switch button 10 and activations of headlight 13 and side light 15 may also practice the present invention.

In one embodiment, headlight 13 may be operated in a continuous mode to allow maximum illumination of the area in front of a walker. In another embodiment, headlight 13 may be operated in a flashing mode to provide additional safety when walking along roadways, shoulders or verges.

In another embodiment, side light 15 may be operated in a continuous mode to allow maximum illumination of the footpath or walkway. In another embodiment, side light 15 may be operated in an intermittent or flashing mode to provide additional safety when walking along roadways, shoulders or verges.

In one embodiment of the disclosed walking stick, the headlight and side light may both be a white color. In another embodiment, the headlight and sidelight may be different colors. In one embodiment, the headlight may be a white color, and the sidelight may be a red color. Operating the red sidelight in the flashing mode as disclosed previously may further aid in visibility when walking along roadways, shoulders or verges.

We claim:

1. An apparatus for a lighted walking stick, comprising:
a handle with interior cavity,
a telescoping tube,
a telescoping tube joint, and
a foot pad.

2. The apparatus of claim 1, wherein said handle with interior cavity further comprises a battery.

3. The apparatus of claim 2, wherein said handle with interior cavity further comprises a front-facing headlight.

4. The apparatus of claim 3, wherein said handle with interior cavity further comprises a downward-facing sidelight.

5. The apparatus of claim 3, wherein said handle with interior cavity further comprises a switch button to control operation of said light.

6. The apparatus of claim 4, wherein said handle with interior cavity further comprises a switch button to control operation of said lights.

7. The apparatus of claim 5, wherein said front-facing headlight operates in a continuous mode.

9. The apparatus of claim 5, wherein said front-facing headlight operates in a flashing mode.

10. The apparatus of claim 6, wherein said front-facing headlight operates in a continuous mode.

11. The apparatus of claim 6, wherein said front-facing headlight operates in a flashing mode.

12. The apparatus of claim 6, wherein said downward-facing sidelight operates in a continuous mode.

13. The apparatus of claim 6, wherein said downward-facing sidelight operates in a flashing mode.

14. The apparatus of claim 2, wherein said handle further comprises a charging interface for supplying external electrical charge to said battery.

15. A method of operating a lighted walking stick, comprising:
engaging a switch mechanism,
enabling one or more lights, and
controlling the operating mode of the one or more lights.

16. The method of claim 15, wherein engaging a switch mechanism comprises depressing a switch button.

17. The method of claim 15, wherein said operating mode comprises a continuous mode of operation.

18. The method of claim 15, wherein said operating mode comprises an intermittent mode of operation.
